(19) United States
(12) Patent Application Publication
(10) Pub. No.: US 2010/0191987 A1
(43) Pub. Date: Jul. 29, 2010

(54) Semiconductor device using plural external voltage and data processing system including the same

(75) Inventors: Kiyohiro Furutani, Tokyo (JP); Shoji Kaneko, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Elpida Memory, Inc., Tokyo (JP)

(21) Appl. No.: 12/656,402

(22) Filed: Jan. 28, 2010

(30) Foreign Application Priority Data
Jan. 29, 2009 (JP) 2009-017484

(51) Int. Cl. G06F 1/26; H02J 1/00

(52) U.S. Cl. 713/300; 307/82; 307/80

(57) ABSTRACT

To provide a first internal voltage generating circuit that generates an internal voltage based on a first external voltage and a second internal voltage generating circuit that generates the internal voltage based on a second external voltage. The semiconductor device generates an internal voltage from a plurality of the first and second external voltages. These external voltages can be utilized efficiently depending on a load state. Therefore, even in a semiconductor device with greatly varying consumption power, it is not necessary to enlarge only a particular power supply device.

### BACKGROUND OF THE INVENTION

1. Field of the Invention

The present invention relates to a semiconductor device, and more particularly relates to a semiconductor device operated by a plurality of external voltages. The present invention also relates to a data processing system including a power supply device that generates different external voltages.

2. Description of Related Art

An internal voltage used in a semiconductor device can be different from an external voltage supplied from outside. In this case, an internal voltage generating circuit that converts the external voltage into the internal voltage is prepared for the semiconductor. That is, when the external voltage is higher than the internal voltage, the external voltage is decreased by the internal voltage generating circuit. Conversely, when the external voltage is lower than the internal voltage, the external voltage is increased by the internal voltage generating circuit.

Some semiconductor devices use a plurality of internal voltages. In such semiconductor devices, a plurality of internal voltage generating circuits are provided (see Japanese Patent Application Laid-open No. 2007-13190).

In addition to the semiconductor device, other semiconductor devices and various electronic components are mounted on a mounting substrate of the semiconductor device and external voltages are supplied from power supply devices on the mounting substrate. Accordingly, plural types of external voltages can exist on the mounting substrate.

In the above case, when the semiconductor device with large consumption power relies on only an external voltage, the load of the power supply device that generates the corresponding external voltage becomes large. Particularly in semiconductor devices with greatly varying consumption power, the power supply device needs to be designed to supply the maximum consumption power, and thus the power supply device is difficult to be downsized.

### SUMMARY

The present invention seeks to solve one or more of the above problems, or to improve upon those problems at least in part.

In one embodiment, there is provided a semiconductor device that includes a first internal voltage generating circuit that generates an internal voltage based on a first external voltage and a second internal voltage generating circuit that generates the internal voltage based on a second external voltage different from the first external voltage.

In another embodiment, there is provided a data processing system that includes a first power supply device that generates a first external voltage, a second power supply device that generates a second external voltage different from the first external voltage, and a semiconductor device operated by at least the first and second external voltages. The semiconductor device includes a first internal voltage generating circuit that generates an internal voltage based on the first external voltage and a second internal voltage generating circuit that generates the internal voltage based on the second external voltage.

Because the semiconductor device according to the present invention generates an internal voltage from a plurality of external voltages, it can utilize these external voltages efficiently according to the load state. Therefore, even in the semiconductor device with greatly varying consumption power, it is not necessary to enlarge only a particular power supply device. Accordingly, power supply devices used for a data processing system can be downsized.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram of a data processing system according to a preferred embodiment of the present invention;

FIG. 2 is a block diagram of a configuration of the semiconductor device;

FIG. 3 is a circuit diagram showing an example of the internal voltage generating circuits;

FIG. 4 is another example of the internal voltage generating circuits;

FIG. 5 is still another example of the internal voltage generating circuits;

FIGS. 6A to 6C are waveform diagrams of the control signals;

FIG. 7 is a block diagram showing an example of adding an another internal voltage generating circuit to the semiconductor device shown in FIG. 2;

FIG. 8 is a preferred layout of the internal voltage generating circuits when the memory cell array is divided into four banks;

FIG. 9 is a circuit diagram of the sense amplifier and the sense amplifier driving circuit;

FIG. 10 is a circuit diagram of the power supply control circuit; and

FIG. 11 is a waveform diagram for explaining the sense operation of the semiconductor device according to the present embodiment.

### DETAILED DESCRIPTION OF THE EMBODIMENTS

Preferred embodiments of the present invention will be explained below in detail with reference to the accompanying drawings.

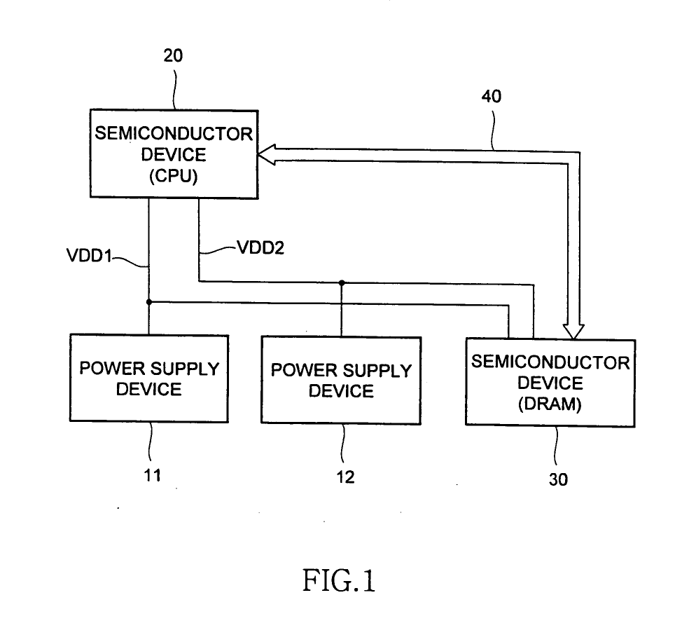

FIG. 1 is a block diagram of a data processing system according to a preferred embodiment of the present invention.

As shown in FIG. 1, the data processing system according to the present embodiment includes a power supply device 11 that generates an external voltage VDD1 and a power supply device 12 that generates an external voltage VDD2. Both of the external voltages VDD1 and VDD2 are supplied to semiconductor devices 20 and 30. The semiconductor devices 20 and 30 are operated by the two external voltages VDD1 and VDD2. As an example, the semiconductor device 20 is a CPU (Central Processing Unit) and the semiconductor device 30 is a DRAM (Dynamic Random Access Memory), and these devices are connected to each other by a bus 40. The configuration of the data processing system is not limited thereto and other devices, for example a semiconductor device such as graphic chips and a ROM, an external memory device such as a hard disk device and an optical drive, and an I/O device such as a keyboard and a speaker, can be connected to the bus 40.

Maximum current supply capabilities (current limit values) in specs of systems are determined for the power supply devices 11 and 12, respectively. Therefore, the semiconductor devices 20 and 30 that utilize the external voltages VDD1 and VDD2 can be supplied with power from the power supply devices 11 and 12 within the respective ranges of the current limit values. The current limit values of the power supply devices 11 and 12 depend on constituent elements in the systems, and as the power to be supplied is increased, the power supply device is designed to be enlarged.

Explanations are made below while focusing on the semiconductor device 30, which is a DRAM.

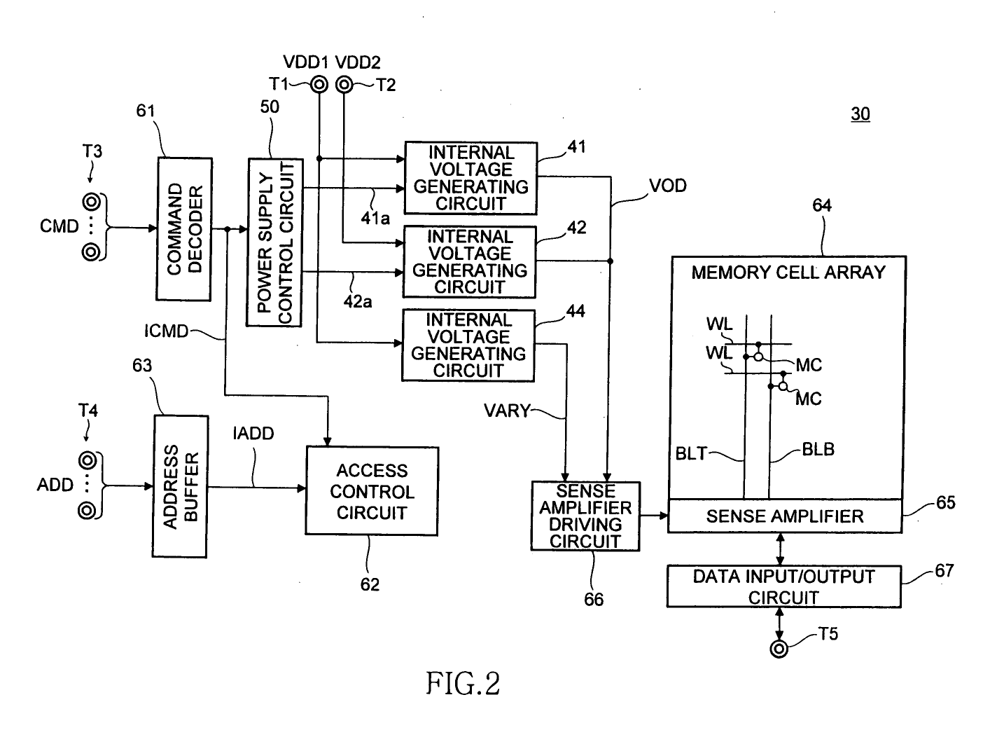

FIG. 2 is a block diagram of a configuration of the semiconductor device 30.

As shown in FIG. 2, the semiconductor device 30 includes an internal voltage generating circuit 41 that generates an internal voltage VOD based on the external voltage VDD1 and an internal voltage generating circuit 42 that generates the internal voltage VOD based on the external voltage VDD2. The external voltage VDD1 is different from the external voltage VDD2. The external voltages VDD1 and VDD2 are supplied from outside via terminals T1 and T2, respectively. The internal voltage VOD is thus generated from the different external voltages VDD1 and VDD2. The semiconductor device 30 further includes an internal voltage generating circuit 44 that generates another internal voltage VARY from the external voltage VDD1 (or the external voltage VDD2).

Operations of the internal voltage generating circuits 41 and 42 are controlled by a power supply control circuit 50. The power supply control circuit 50 selectively activates the internal voltage generating circuits 41 and 42 by control signals 41a and 42a and its selection is determined by an internal command ICMD. The internal command ICMD is an internal signal generated by a command decoder 61 that receives external commands CMD. The external command CMD is supplied from outside via terminals T3. For example, when the external command CMD indicates an active command, the command decoder 61 activates an active signal ACT which is one of the internal commands ICMD. When the external command CMD indicates a self refresh command, the command decoder 61 activates a refresh signal REF which is one of the internal commands ICMD.

The internal command ICMD is also supplied to an access control circuit 62. The access control circuit 62 receives the internal command ICMD from the command decoder 61 and an internal address IADD from an address buffer 63 to select a memory cell designated by the internal address IADD among memory cells MC included in a memory cell array 64. An external address ADD is supplied from outside via terminals T4. As shown in FIG. 2, the memory cells MC are arranged at intersections of word lines WL with bit lines BLT and BLB.

The memory cell MC selected by the access control circuit 62 is connected to the corresponding bit line BLT or BLB and a potential difference is amplified by a sense amplifier 65 connected to a pair of bit lines BLT and BLB. An operation voltage of the sense amplifier 65 is supplied by a sense amplifier driving circuit 66. As shown in FIG. 2, at least the internal voltage VOD and the internal voltage VARY are supplied to the sense amplifier driving circuit 66.

The internal voltage VARY corresponds to the potential difference between the bit lines BLT and BLB amplified by the sense amplifier 65. Meanwhile, the internal voltage VOD overdrives the sense amplifier 65 during an initial activation of the sense amplifier 65. Accordingly, VOD>VARY is established. The sense amplifier 65 is overdriven in an initial period of a sense operation to amplify the potential difference between the bit lines BLT and BLB more quickly to the internal voltage VARY.

Read data amplified by the sense amplifier 65 is supplied to a data input/output circuit 67 and then outputted to outside the semiconductor device 30 via a terminal T5. Further, write data inputted from the external of the semiconductor device 30 is supplied via the terminal T5 and data input/output circuit 67 to the sense amplifier 65 and then written in the memory cell array 64.

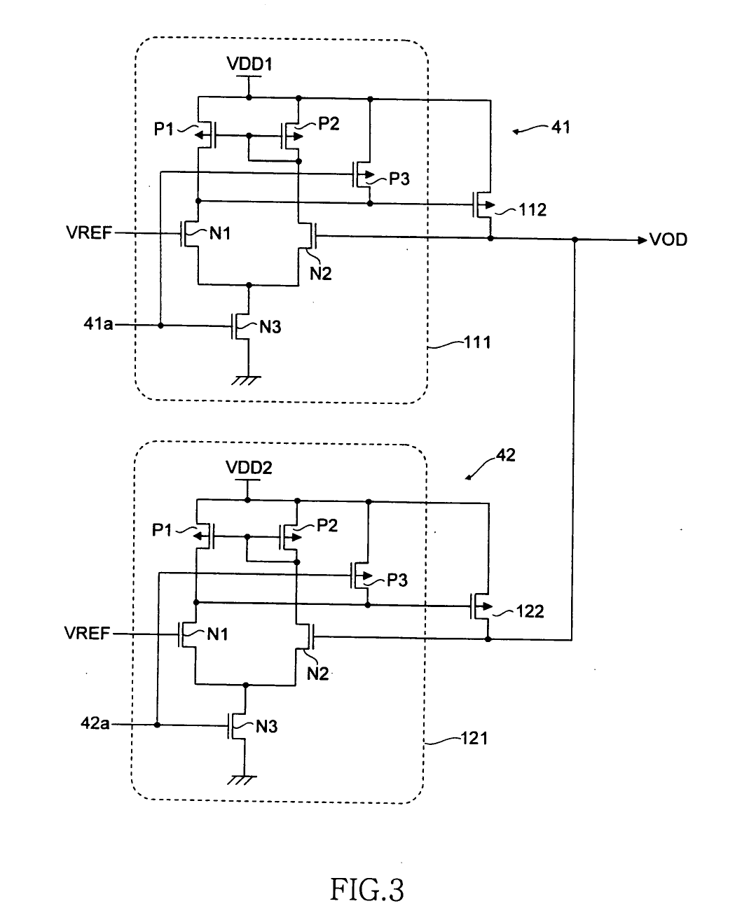

FIG. 3 is a circuit diagram showing an example of the internal voltage generating circuits 41 and 42. This example shows a circuit suitable when the external voltages VDD1 and VDD2 are higher than the internal voltage VOD. For example, the external voltage VDD1 is 2.0 V, the external voltage VDD2 is 1.8 V, and the internal voltage VOD is 1.4 V.

According to the example of FIG. 3, the internal voltage generating circuits 41 and 42 include respectively by internal voltage control units 111 and 121 that constitute differential amplifiers and voltage generation drivers 112 and 122 that output the internal voltage VOD. Specifically, the internal voltage control units 111 and 121 include respectively input transistors N1 and N2, source transistors N3 connected to sources of the input transistors N1 and N2, and transistors P1 and P2 serially connected to the input transistors N1 and N2, respectively to constitute current mirror circuits. A reference voltage VREF is supplied to gate electrodes of one input transistors N1 and outputs (=VOD) of the voltage generation drivers 112 and 122 are returned to gate electrodes of the other input transistors N2.

The voltage generation drivers 112 and 122 is constituted by P-channel MOS transistors and their gate electrodes are connected to drains of the input transistors N1. Because of such a configuration, when a level of the internal voltage VOD serving as the output becomes lower than the reference voltage VREF, the voltage generation drivers 112 and 122 are turned on and the level of the internal voltage VOD is increased. When the level of the internal voltage VOD is increased to the reference voltage VREF, the voltage generation drivers 112 and 122 are turned off.

The control signals 41a and 42a are supplied respectively to the source transistors N3 in the internal voltage control units 111 and 121. When the control signals 41a and 42a become high level, the internal voltage control units 111 and 121 that constitute the differential amplifiers are activated, so that the above operations by the voltage generation drivers 112 and 122 are performed. On the other hand, when the control signals 41a and 42a become low level, the internal voltage control units 111 and 121 are inactivated and transistors P3 are turned on, so that the voltage generation drivers 112 and 122 remain turned off.

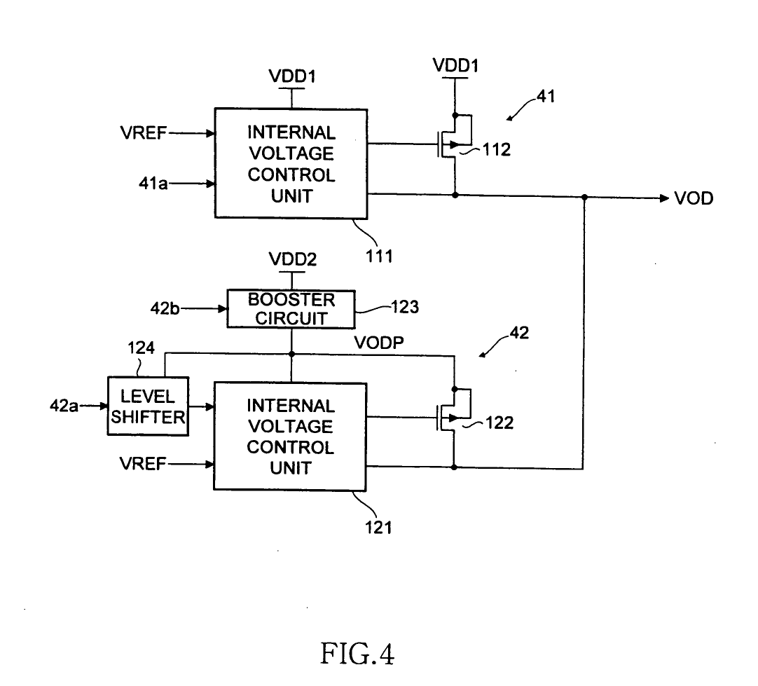

FIG. 4 shows another example of the internal voltage generating circuits 41 and 42. This example shows a circuit suitable when the external voltage VDD1 is higher than the internal voltage VOD and the external voltage VDD2 is lower than the internal voltage VOD. For example, the external voltage VDD1 is 1.8 V, the external voltage VDD2 is 1.2 V, and the internal voltage VOD is 1.4 V.

In this example, because the external voltage VDD2 is lower than the internal voltage VOD, the internal voltage generating circuit 42 is provided with a booster circuit 123. The booster circuit 123 increases the external voltage VDD2 to an internal voltage VODP. The internal voltage VODP is an intermediate voltage for generating the internal voltage VOD and not particularly limited as long as it is higher than the internal voltage VOD, which is 1.9 V.

The booster circuit 123 is activated based on a boost control signal 42b to generate the internal voltage VODP. The generated internal voltage VODP is supplied to the internal voltage control unit 121 and the voltage generation driver 122 for their operation voltage. Further, the internal voltage VODP is also supplied to a level shifter 124 and a level of the control signal 42a is shifted by the level shifter 124.

As described above, because the internal voltage generating circuit 42 shown in FIG. 4 includes the booster circuit 123, the internal voltage VODP needs to be increased to a predetermined value (for example, 1.9 V) when the control signal 42a is activated. Accordingly, the boost control signal 42b needs to be activated at a timing at least prior to the activation of the control signal 42a.

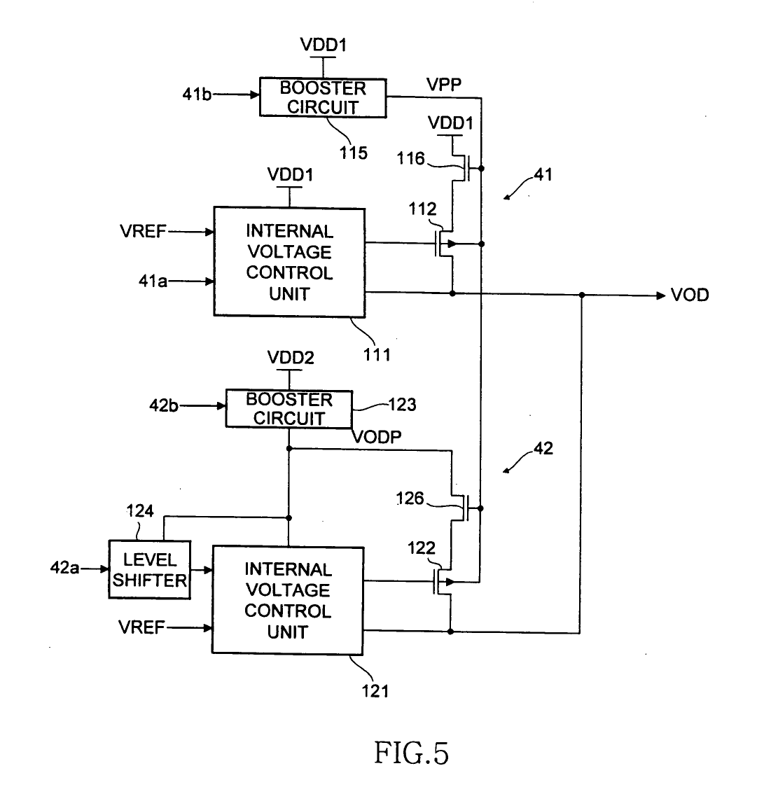

FIG. 5 shows still another example of the internal voltage generating circuits 41 and 42. This example also shows a circuit suitable when the external voltage VDD1 is higher than the internal voltage VOD and the external voltage VDD2 is lower than the internal voltage VOD. For example, the external voltage VDD1 is 1.8 V, the external voltage VDD2 is 1.2 V, and the internal voltage VOD is 1.4 V.

According to this example, in addition to the circuit shown in FIG. 4, a booster circuit 115 that increases the external voltage VDD1 to generate an internal voltage VPP and source control circuits 116 and 126 connected respectively to the sources of the voltage generation drivers 112 and 122 are added.

The booster circuit 115 is activated based on a boost control signal 41b to generate the internal voltage VPP. The generated internal voltage VPP is, for example, 2.7 V, and supplied to gate electrodes of N-channel MOS transistors that constitute the source control circuits 116 and 126. When the boost control signal 41b is activated, the source control circuits 116 and 126 are turned on. The internal voltage can thus be outputted from the voltage generation drivers 112 and 122. When the boost control signal 41b is not activated, the source control circuits 116 and 126 are turned off. The voltage generation drivers 112 and 122 are thus disconnected from power supplies.

The internal voltage VPP is also applied to substrates of P-channel MOS transistors that constitute the voltage generation drivers 112 and 122. That is, a back bias higher than the external voltages VDD1 and VDD2 is applied to the P-channel MOS transistors that constitute the voltage generation drivers 112 and 122. Even if generation of the internal voltage VODP by a booster circuit 123 is delayed, a substrate (N-type) and a drain (P-type) of the P-channel MOS transistor that constitute the voltage generation driver 122 are not forward biased.

Assume that a back bias of the voltage generation driver 122 is the internal voltage VODP as shown in FIG. 4. When the internal voltage VOD is made to rise by the internal voltage generating circuit 41 before the internal voltage VODP is generated by the booster circuit 123, the substrate (N-type) and the drain (P-type) of the P-channel MOS transistor that constitute the voltage generation driver 122 are forward biased, so that a current flows in an opposite direction. When the back bias of the voltage generation driver 122 is the internal voltage VPP (>VODP) as in this example, such current generation can be prevented, thereby reducing the consumption power.

The internal voltage VPP satisfies preferably VPP-Vt>VDD1 or VODP, considering a threshold voltage Vt of the N-channel MOS transistors that constitute the source control circuits 116 and 126.

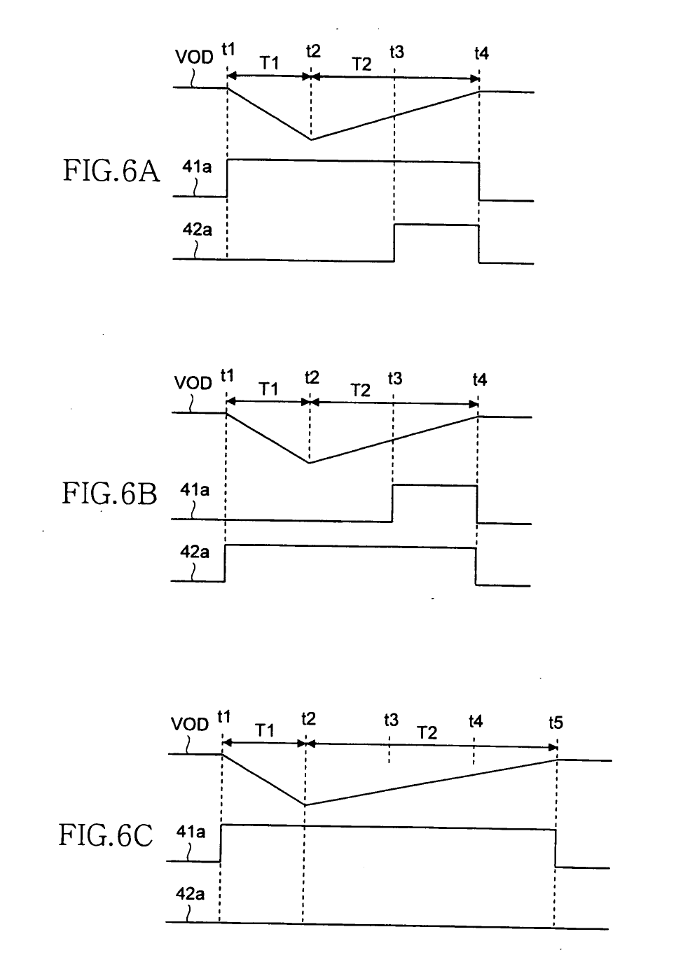

FIGS. 6A to 6C are waveform diagrams of the control signals 41a and 42a.

In FIGS. 6A to 6C, a period that the internal circuit using the internal voltage VOD (the sense amplifier driving circuit 66) is activated is indicated by T1 (from a time t1 to a time t2). In the activation period T1, the level of the internal voltage VOD is decreased because of charge emission. By operating the internal voltage generating circuits 41 and 42, the internal voltage returns to its original level through a recovery period T2 (from the time t2 to a time t4 or from the time t2 to a time t5).

According to the pattern shown in FIG. 6A, the control signal 41a is activated from the time t1 at which the activation period T1 starts to the time t4 at which the recovery period T2 ends. Further, the control signal 42a is activated from the time t3 at which the activation period T1 has already ended to the time t4. That is, this is a pattern of activating the internal voltage generating circuit 41 longer than the internal voltage generating circuit 42. As the internal voltage generating circuits 41 and 42 are activated during a part of the recovery period T2 in the pattern, the internal voltage VOD can be returned to its original level quickly. Thus, the pattern shown in FIG. 6A is a pattern suitable in a normal operation (a read operation and a write operation). This is because the subsequent active signal ACT can be activated at a relatively early timing in the normal operation and thus the internal voltage VOD needs to be compensated earlier.

The pattern shown in FIG. 6A is suitable when the current limit value (spec) of the external voltage VDD1 is relatively large and the current limit value of the external voltage VDD2 is relatively small. This pattern is also suitable when the level of the external voltage VDD2 is lower than the internal voltage VOD and thus the booster circuit 123 needs to be used as in the examples of FIGS. 4 and 5. This is because losses are generated by the booster circuit 123 and a conversion efficiency of the internal voltage generating circuit 42 is lower than that of the internal voltage generating circuit 41 accordingly. By using the internal voltage generating circuit 41 with higher efficiency preferentially, the total consumption power can be suppressed. In this case, it is desirable that the internal voltage generating circuit 41 is used to the extent of satisfying the current limit value of the external voltage VDD1 and the internal voltage generating circuit 42 is used in a complementary manner.

The pattern shown in FIG. 6B is opposite to that shown in FIG. 6A. The control signal 42a is activated from the time t1 to the time t4 and the control signal 41a is activated from the time t3 to the time t4. That is, this is a pattern of activating the internal voltage generating circuit 42 longer than the internal voltage generating circuit 41. This pattern is suitable when the current limit value of the external voltage VDD2 is relatively large and the current limit value of the external voltage VDD1 is relatively small. In this case, it is desirable that the internal voltage generating circuit 42 is used to the extent of satisfying the current limit value of the external voltage VDD2 and the internal voltage generating circuit 41 is used in a complementary manner.

According to the pattern shown in FIG. 6C, the control signal 41a is activated during a period from the time t1 at which the activation period T1 starts to the time t5 at which the recovery period T2 ends and the control signal 42a is maintained inactivated. The time t5 is a timing later than the time t4 shown in FIGS. 6A and 6B. The pattern shown in FIG. 6C is a pattern using only the internal voltage generating circuit 41 and providing the enlarged recovery period T2.

This pattern is suitable when the internal voltage VOD does not need to be compensated early like a self-refreshing operation. Naturally, the current limit value of the external voltage VDD1 must not be exceeded. Therefore, even if the conversion efficiency of the internal voltage generating circuit 42 is lower than that of the internal voltage generating circuit 41, the consumption power can be minimized because only the internal voltage generating circuit 41 with higher efficiency is used.

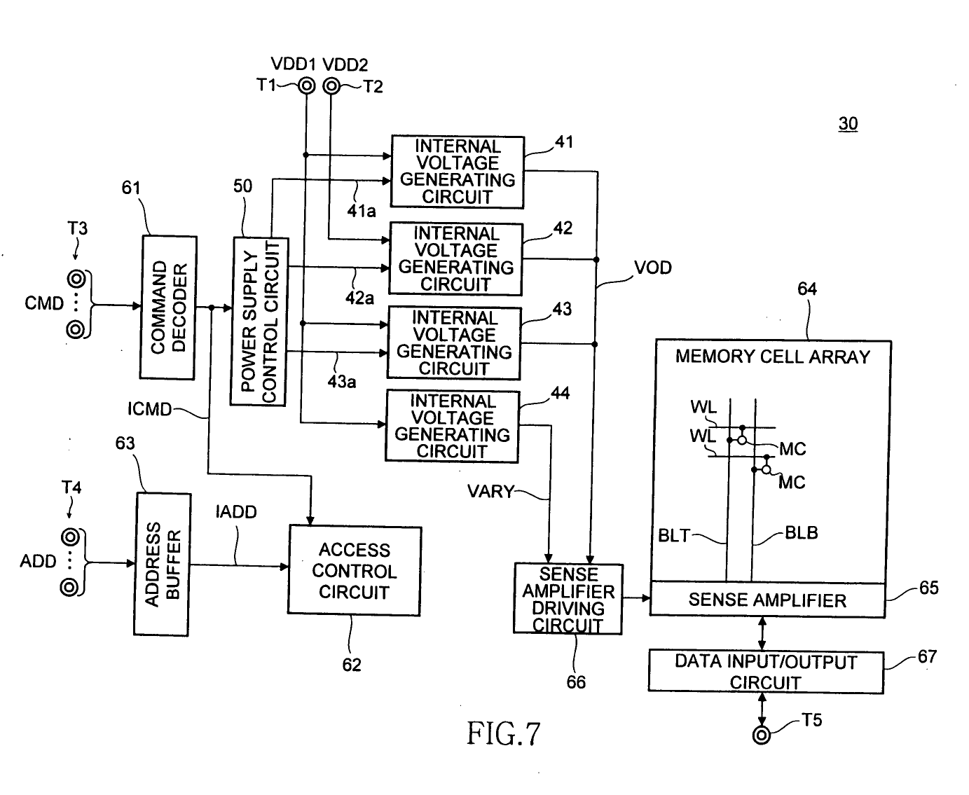

FIG. 7 is a block diagram showing an example of adding an internal voltage generating circuit 43 to the semiconductor device 30 shown in FIG. 2.

The internal voltage generating circuit 43 generates the internal voltage VOD based on the external voltage VDD1 and its configuration is the same as in the internal voltage generating circuit 41 shown in FIG. 3. An operation of the internal voltage generating circuit 43 is controlled by a control signal 43a supplied by the power supply control circuit 50. The control signal 43a is maintained activated unless the internal voltage generating circuit 43 is in a deep power down mode (a non-access state and generation of potentials of internal power supplies is stopped). That is, unless it is in the deep power down mode, the internal voltage generating circuit 43 continues to be operated regardless of whether the internal circuit using the internal voltage VOD (the sense amplifier driving circuit 66) is activated or inactivated.

By providing the internal voltage generating circuit 43, a decrease in the internal voltage VOD during standby can be prevented. Because the internal voltage generating circuit 43 is provided to prevent a decrease in the internal voltage VOD during standby, a voltage generation driver (not shown) included in the internal voltage generating circuit 43 can be fabricated in smaller size than the ones in the internal voltage generating circuits 41 and 42.

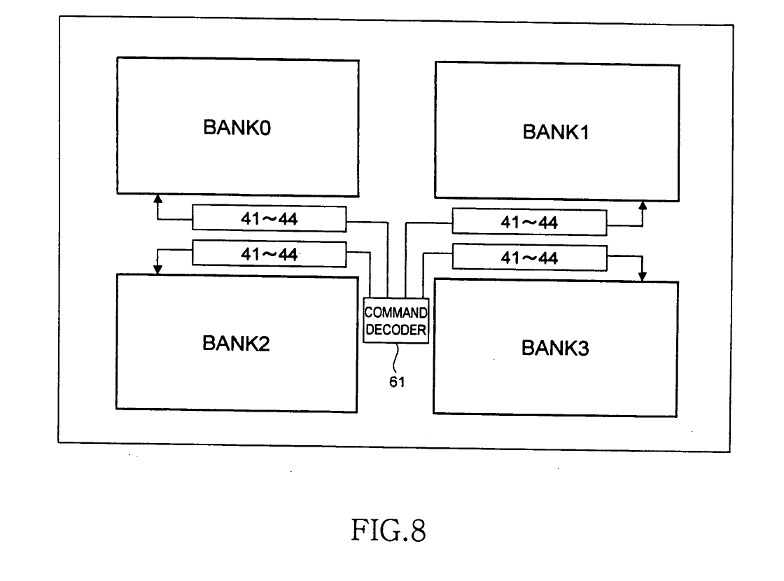

FIG. 8 shows a preferred layout of the internal voltage generating circuits when the memory cell array 64 is divided into four banks BANK0 to BANKS.

As shown in FIG. 8, when the memory cell array 64 is divided into a plurality of banks, it is preferred that each set of the internal voltage generating circuits 41 to 44 is allocated to each bank. Such a configuration allows the sets of the internal voltage generating circuits 41 to 44 to be controlled according to activation/inactivation of the respective banks. As compared to a case of providing one set of the internal voltage generating circuits 41 to 44 for the entire DRAM, the consumption current can be reduced.

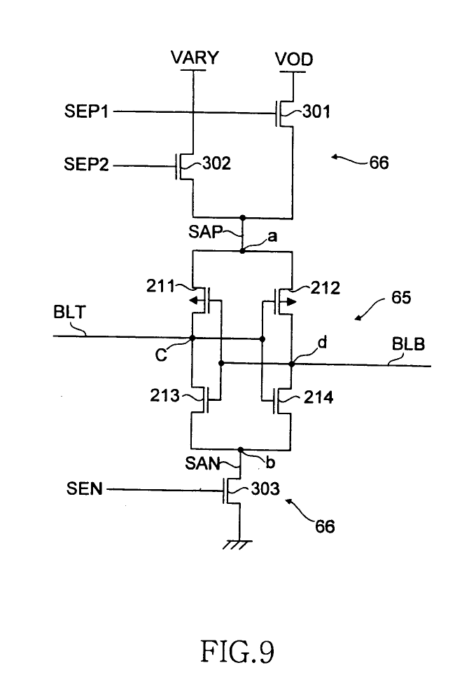

FIG. 9 is a circuit diagram of the sense amplifier 65 and the sense amplifier driving circuit 66.

The sense amplifier 65 is constituted by of P-channel MOS transistors 211 and 212 and N-channel MOS transistors 213 and 214. The P-channel MOS transistor 211 is serially connected to the N-channel MOS transistor 213 between a power supply node a and a power supply node b, their contact is connected to one signal node c, and their gate electrodes are connected to the other signal node d. Similarly, the P-channel MOS transistor 212 is serially connected to the N-channel MOS transistor 214 between the power supply node a and the power supply node b, their contact is connected to one signal node d and their gate electrodes are connected to the other signal node c. The signal node c is connected to one bit line BLT and the signal node d is connected to the other bit line BLB.

Because of such a flip-flop structure, when a potential difference between a pair of bit lines BLT and BLB is generated while predetermined potentials are supplied to an upper drive wiring SAP and a lower drive wiring SAN, a potential of the upper drive wiring SAP is supplied to one of the bit line pair and a potential of the lower drive wiring SAN is supplied to the other of the bit line pair.

The sense amplifier driving circuit 66 is constituted by a driver 301 that supplies the internal voltage VOD to the upper drive wiring SAP, a driver 302 that supplies the internal voltage VARY to the upper drive wiring SAP, and a driver 303 that connects the lower drive wiring SAN to a ground potential. The internal voltage VARY and the internal voltage VOD are defined by the potential difference with respect to the ground potential. The drivers 301 to 303 are controlled by activation signals SEP1, SEP2, and SEN, respectively.

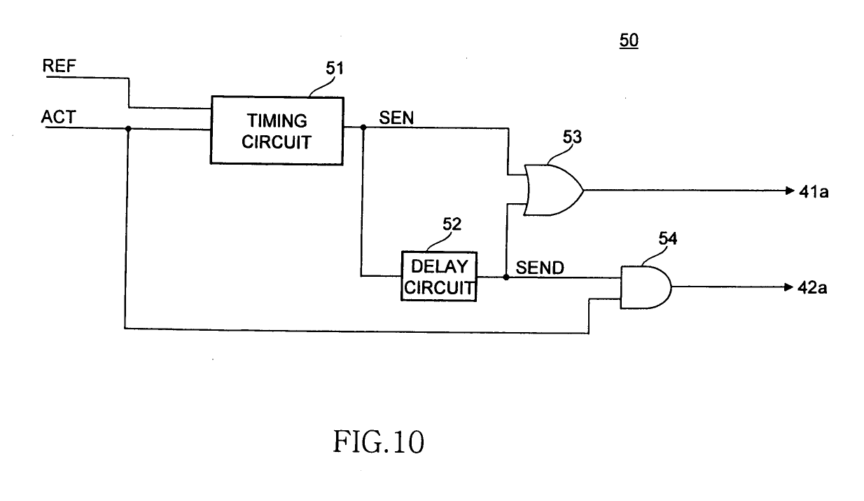

FIG. 10 is a circuit diagram of the power supply control circuit 50.

As shown in FIG. 10, the power supply control circuit 50 includes a timing circuit 51 that receives the active signal ACT and the refresh signal REF to generate an activation signal SEN and a delay circuit 52 that generates a delay signal SEND obtained by delaying the activation signal SEN. The activation signal SEN and the delay signal SEND are inputted to an OR gate 53 and its OR output is used as the control signal 41a. The delay signal SEND and the active signal ACT are inputted to an AND gate 54 and its AND output is used as the control signal 42a.

Because of such a configuration, when the active signal ACT is activated, the control signal 41a is activated to high level during a fixed period and the control signal 42a is activated to high level during a fixed period at the end of activation period of the control signal 41a as shown in FIG. 6A. Meanwhile, when the refresh signal REF is activated, the control signal 41a is activated to high level during a fixed period but the control signal 42a is maintained inactivated as shown in FIG. 6C.

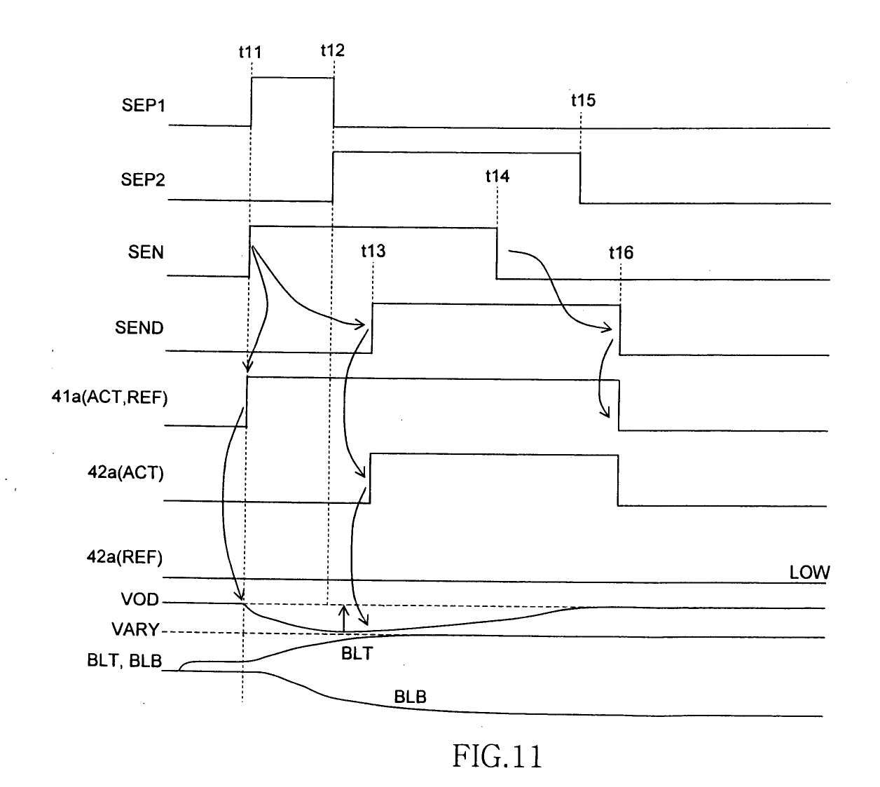

FIG. 11 is a waveform diagram for explaining the sense operation of the semiconductor device 30 according to the present embodiment.

As shown in FIG. 11, when the sense operation starts at a time t11, the activation signals SEP1 and SEN are activated. As described above, the activation signal SEP1 controls the driver 301 and the activation signal SEN controls the driver 303. The internal voltage VOD is thus supplied between the power supply nodes a and b of the sense amplifier 65. The internal voltage VOD higher than the internal voltage VARY is used in the initial period of the sense operation, because the potential difference between the bit lines BLT and BLB is amplified more quickly by overdrive.

Thereafter, the activation signal SEP1 is inactivated at a time t12 and overdrive ends. The activation signal SEP2 is then activated and thus the internal voltage VARY is supplied between the power supply nodes a and b of the sense amplifier 65. The activation signal SEP2 is inactivated at a time t15 and the activation signal SEN is inactivated at a time t14.

Meanwhile, as the delay signal SEND which is activated from a time t13 to a time t16 is generated by the power supply control circuit 50 shown in FIG. 10, the control signal 41a is activated from the time t11 to the time t16. The internal voltage generating circuit 41 is activated during this period and the reduced internal voltage VOD is compensated.

The waveform of the control signal 42a varies depending on whether the sense operation is due to the active signal ACT or the refresh signal REF. When the sense operation is due to the active signal (42a (ACT)), the control signal 42a is activated from the time t13 to the time t16 by the power supply control circuit 50 shown in FIG. 10. That is, the internal voltage generating circuit 42 is activated during this period and the reduced internal voltage VOD is compensated. As the internal voltage VOD reduced by the sense operation is compensated by the two internal voltage generating circuits 41 and 42 (three internal voltage generating circuits when the internal voltage generating circuit 43 is added), the voltage is recovered quickly.

When the sense operation is due to the refresh signal (42a (REF)), the control signal 42a is maintained inactivated. The internal voltage generating circuit 42 is not activated and the internal voltage VOD reduced by the sense operation is compensated by only one internal voltage generating circuit 41 (two internal voltage generating circuits when the internal voltage generating circuit 43 is added). The voltage is thus recovered relatively gently.

As described above, according to the present embodiment, when the sense operation is performed due to the active signal ACT, that is, in the normal read or write operation, the internal voltage VOD is driven by the internal voltage generating circuits 41 and 42. Meanwhile, when the sense operation is performed due to the refresh signal REF, the internal voltage VOD is driven only by the internal voltage generating circuit 41. That is, in a normal operation that the internal voltage VOD reduced by the sense operation needs to be recovered quickly, the compensation is performed by the two internal voltage generating circuits 41 and 42. In a self-refreshing operation that the internal voltage VOD reduced by the sense operation does not need to be recovered quickly, the compensation is performed only by the internal voltage generating circuit 41. With this arrangement, the consumption power during the self-refreshing operation can thus be reduced while successive high speed accesses can be realized.

Furthermore, as the compensation is performed by the internal voltage generating circuits 41 and 42 using different external voltages VDD1 and VDD2 in the normal operation, the load is not centralized only on a particular external power supply.

It is apparent that the present invention is not limited to the above embodiments, but may be modified and changed without departing from the scope and spirit of the invention.

For example, in the above embodiment, while the internal voltage generating circuits 41 and 42 that generate the internal voltage VOD by using different external voltages VDD1 and VDD2 are selectively activated, three or more internal voltage generating circuits that use three or more external voltages with different levels can be selectively activated.

In the above embodiment, while the operation of the internal voltage generating circuits 41 and 42 during the activation of the active signal ACT is different from the operation during the activation of the refresh signal REF, the operation of the internal voltage generating circuits 41 and 42 can be controlled according to other signals (for example, a pre-charge signal).

Further, the activation period of the internal voltage generating circuits 41 and 42 does not need to be fixed, and can be varied freely by changing, for example, the delay amount of the delay circuit 52.

What is claimed is:

1. A semiconductor device comprising:
a first internal voltage generating circuit that generates an internal voltage based on a first external voltage; and
a second internal voltage generating circuit that generates the internal voltage based on a second external voltage different from the first external voltage.

2. The semiconductor device as claimed in claim 1, wherein the first and second external voltages are higher than the internal voltage.

3. The semiconductor device as claimed in claim 1, wherein the first external voltage is higher than the internal voltage, the second external voltage is lower than the internal voltage, and the second internal voltage generating circuit includes a booster circuit that increases the second external voltage to equal to or higher than the internal voltage.

4. The semiconductor device as claimed in claim 1, wherein the first and second internal voltage generating circuits include a voltage generation driver having a P-channel MOS transistor that outputs the internal voltage, and a back bias higher than the first and second external voltages is applied to the P-channel MOS transistor.

5. The semiconductor device as claimed in claim 1, further comprising a power supply control circuit that selectively activates the first and second internal voltage generating circuits.

6. The semiconductor device as claimed in claim 5, wherein the power supply control circuit activates the first internal voltage generating circuit at least during an activation period of an internal circuit that uses the internal voltage, and activates the second internal voltage generating circuit after the activation period of the internal circuit ends.

7. The semiconductor device as claimed in claim 6, wherein the power supply control circuit continuously activates the first internal voltage generating circuit after the activation period of the internal circuit ends, and inactivates the first and second internal voltage generating circuits after a predetermined period elapses since the activation period of the internal circuit ends.

8. The semiconductor device as claimed in claim 6, wherein a current limit value of the first external voltage is relatively large, and a current limit value of the second external voltage is relatively small.

9. The semiconductor device as claimed in claim 6, further comprising a sense amplifier that amplifies a potential difference between bit lines, wherein
the internal circuit is a driver that supplies the internal voltage to the sense amplifier during an initial period of activation of the sense amplifier, and
the internal voltage is larger than a potential difference between the bit lines amplified by the sense amplifier.

10. The semiconductor device as claimed in claim 9, wherein the power supply control circuit activates the second internal voltage generating circuit after the driver is turned off in a normal operation, and the power supply control circuit maintains the second internal voltage generating circuit inactivated in a refresh operation.

11. The semiconductor device as claimed in claim 6, further comprising a third internal voltage generating circuit that generates the internal voltage based on the first or second external voltage, wherein
the power supply control circuit activates the third internal voltage generating circuit at least during an inactivation period of the internal circuit.

12. A data processing system comprising:
a first power supply device that generates a first external voltage;
a second power supply device that generates a second external voltage different from the first external voltage; and
a semiconductor device operated by at least the first and second external voltages, wherein
the semiconductor device includes:
a first internal voltage generating circuit that generates an internal voltage based on the first external voltage; and
a second internal voltage generating circuit that generates the internal voltage based on the second external voltage.
